(19) United States
(12) Patent Application Publication
(10) Pub. No.: US 2004/0228623 A1
(43) Pub. Date: Nov. 18, 2004

(54) Information processing apparatus and state notifying method

(75) Inventors: Kenichi Saito, Tachikawa-shi (JP); Kazuyuki Saito, Ome-shi (JP); Kazuyoshi Kuwahara, Akiruno-shi (JP); Michio Seki, Tokyo (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/766,473

(22) Filed: Jan. 29, 2004

(30) Foreign Application Priority Data
Jan. 31, 2003 (JP) 2003-024422

(51) Int. Cl. G08B 23/00

(52) U.S. Cl. 395/750.01; 340/500

(57) ABSTRACT

An information processing apparatus includes a unit for disabling an output of sound information, a unit for detecting a state of the sound information, and a unit for notifying a user of the state of the sound information detected with the unit for detecting the state by using information other than a sound.

### CROSS-REFERENCE TO RELATED APPLICATIONS

This application is based upon and claims the benefit of priority from the prior Japanese Patent Application No. 2003-024422, filed Jan. 31, 2003, the entire contents of which are incorporated herein by reference.

### BACKGROUND OF THE INVENTION

1. Field of the Invention

The present invention relates to an information processing apparatus handling sound information and a state notifying method. More particularly, the present invention relates to an information processing apparatus which is suitably applied to a computer, a multimedia terminal and the like, and which has sound output means for outputting a sound in accordance with sound information and operation means for disabling a sound output from the sound output means, and a state notifying method.

2. Description of the Related Art

With multiple functioning of a computer system, it becomes possible to make recording, reproduction, or communication of voice information, a music program and the like. An apparatus (system) which handles sound information (audio information) incorporates a control circuit which controls input or output of sound information (audio information) called a sound controller or an audio controller, thereby obtaining coincidence with a CPU over a system bus (refer to Jpn. Pat. Appln. KOKAI Publication No. 11-126122, for example).

In an information processing apparatus of this type has operation means for enabling a sound output in processing which does not require a sound output. This operation means includes volume adjustment means by volume control, a sound mute circuit and the like.

Conventionally, when the apparatus is used while these states of the operation means are not checked, even if sound information is handled inside of the apparatus (for example, when information processing or the like together with a voice message or a sound output is handled), there has been a problem that a user cannot recognize such a state.

### BRIEF SUMMARY OF THE INVENTION

An information processing apparatus according to the first aspect of the present invention is characterized by comprising: means for disabling an output of sound information; means for detecting a state of the sound information; and means for notifying a user of the state of the sound information detected with the means for detecting the state by using information other than a sound.

A method of notifying a state of an information processing apparatus which handles sound information, according to the second aspect of the present invention is characterized by comprising: detecting a state of sound information handled by the information processing; and notifying the state of the detected sound information.

### BRIEF DESCRIPTION OF THE SEVERAL VIEWS OF THE DRAWING

The accompanying drawings, which are incorporated in and constitute a part of the specification, illustrate presently preferred embodiments of the present invention, and together with the general description given above and the detailed description of the preferred embodiments given below, serve to explain the principles of the present invention.

FIG. 1 is a perspective view showing an external configuration of an information processing apparatus according to first to third embodiments of the present invention;

FIG. 2 is a block diagram depicting a configuration of the information processing apparatus according to the first to third embodiments;

FIG. 3 is a block diagram depicting a configuration of essential portions according to the first to third embodiments;

FIG. 4 is a flow chart showing procedures for processing according to the first embodiment;

FIG. 5 is a flow chart showing procedures for processing according to the second embodiment; and

FIG. 6 is a flow chart showing a configuration of essential portions according to the third embodiment.

### DETAILED DESCRIPTION OF THE INVENTION

Hereinafter, preferred embodiments of the present invention will be described with reference to the accompanying drawings.

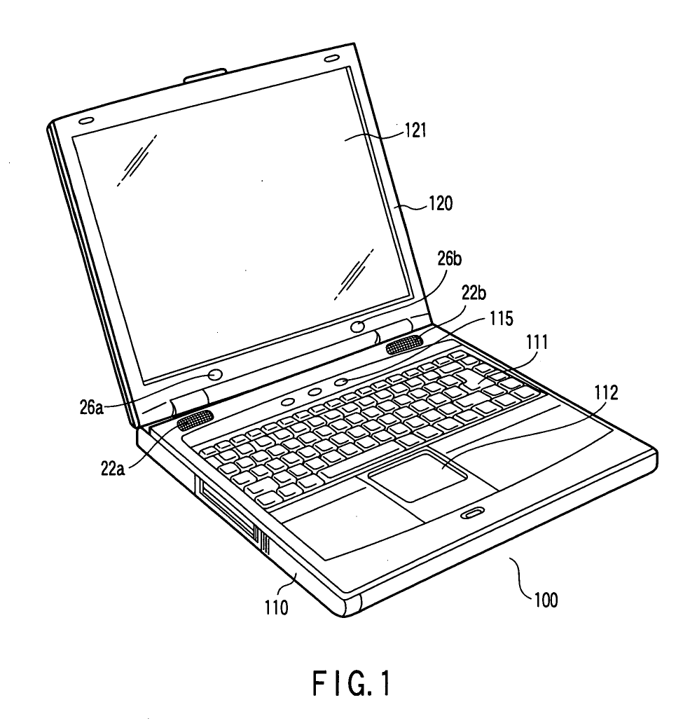

FIG. 1 is a perspective view showing an external configuration of an information processing apparatus according to first to third embodiments of the present invention. FIG. 1 shows a notebook type personal computer.

A computer 100 according to the first to third embodiments of the present invention shown in FIG. 1 has a computer main body 110 and a display unit (display unit cabinet) 120.

The display unit 120 has a display device using an LCD as a display device 121. The display unit 120 having the display device 121 incorporated therein is turnably mounted on the computer main body 110 between an open position and a closed position.

The computer main body 110 has a thin-box-shaped cabinet. The computer main body 110 has a keyboard 20 on its cabinet top face, and has an armrest on a top face of a cabinet portion in front of the keyboard 20. The computer main body 110 has a touch panel 112 at a substantial center part of the armrest. In addition, the computer main body 110 has an executive operating button (presentation button) for instructing display switch of the display device, a mute button 115 for turning ON/OFF a sound mute function, and the like, at the top face of the cabinet portion having the keyboard 111 provided thereon. Further, the computer main body 110 has speakers 22a and 23b used as sound output means at the left and right of the cabinet top face on which the keyboard 20 is allocated, the speakers being capable of outputting a stereo sound. The computer main body 110 has a media slot of an optical disk drive (ODD), a card slot, volume for volume adjustment, and the like, at its side face of the cabinet.

Furthermore, the display unit (display unit cabinet) 120 is used as a sound monitor for causing a user to visually recognize a state of a sound of sound sources sounding the speakers 22a and 23b, respectively, at the left and right side of the lower part on the front face thereof, i.e., a state of sound information handled inside of the apparatus. For example, this display unit has displays 26a and 26b using, for example, an LED. The user visually checks a display state of the displays 26a and 26b (sound monitors), thereby making it possible for the user to reliably recognize the state of sound information handled inside even in a state in which a sound output is disabled by, for example, volume adjustment means by volume control, a sound mute circuit or the like.

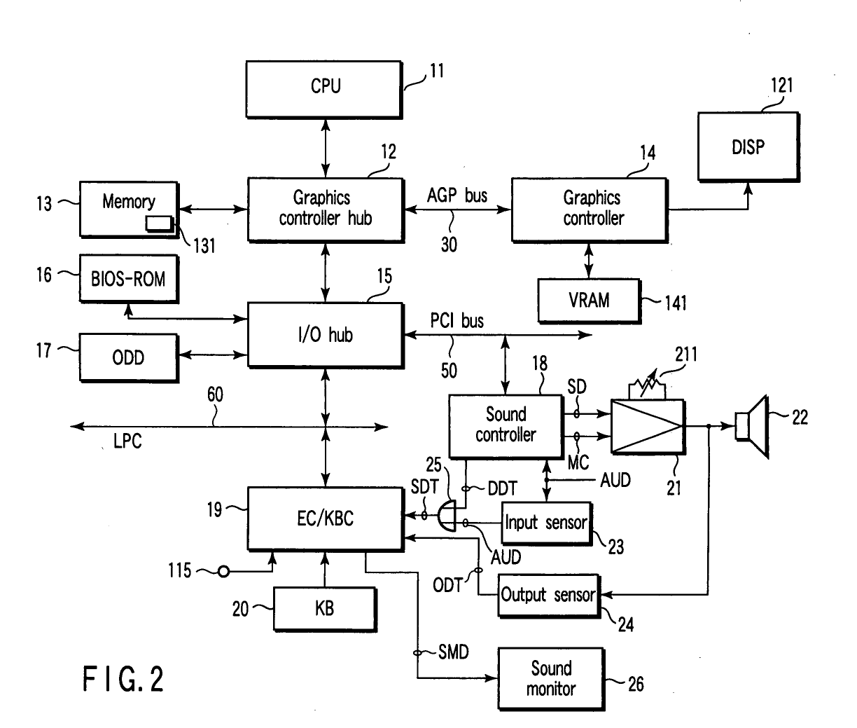

FIG. 2 is a block diagram depicting a system configuration of the computer shown in FIG. 1. A computer system in FIG. 1 shows a notebook type portable personal computer which can be driven by a battery. As shown in FIG. 2, the computer system has a CPU 11, a graphic memory controller hub 12, a memory 13, a graphics controller 14, a VRAM 141, an I/O hub 15, a BIOS-ROM 16, an optical disk drive (ODD) 17, a sound controller 18, a keyboard embedded controller (EC/KBC) 19, a keyboard 20, a sound amplifier 21, a speaker 22, a sound input sensor 23, a sound output sensor 24, an OR circuit 25, a sound monitor 26 and the like. In addition, the memory 13 stores a sound driver.

The sound controller 18 controls input or output of sound information handled by the system. The digital sound data (ODD) inputted from a sound driver 131 controlled with the CPU 11 to the sound controller 18, and an analog sound signal (AUD) is inputted from an external device to the sound controller. Then, the sound controller 18 generates a sound signal (SD) for outputting a sound based on these items of sound information, and sends the sound signal (SD) to the sound amplifier 21.

In addition, the sound controller 18 having received a message (DTM) for detecting digital sound data from the sound driver 131 outputs a digital sound data detection signal (DDT). The sound controller 18 having received a mute command (MC) from the CPU 11 stops operation of the sound amplifier 21 according to the mute command (MC), and disables a sound output.

The keyboard embedded controller (EC/KBC) 19 is configured with an integrated device including a microprocessor which achieves a function of a system power supply management, a keyboard controller and the like. This controller carries out input processing from the keyboard 20 and mute button 115, etc. In addition, the keyboard embedded controller (EC/KBC) 19 inputs a sound output detection signal (ODT) outputted from the sound output sensor 24 and a sound detection signal (SDT) outputted from the OR circuit 25, generates a sound monitor drive signal (SMD) based on these signals, and operationally controls the sound monitor 26 by means of the sound monitor drive signal (SMD). This keyboard embedded controller (EC/KBC) 19 is referred to as an EC/KBC.

The sound amplifier 21 amplifies a sound signal (SD) inputted from the sound controller 18. The speaker 22 (22a, 22b) outputs a sound in accordance with the sound signal (SD) amplified by the sound amplifier 21. The amplitude of the sound amplifier 21 is controlled by a volume 211 for volume adjustment. In addition, when a mute command (MC) caused by operation of a mute button 115 is inputted from the sound controller 18, the sound amplifier 21 stops an amplifying operation, and disables a sound output.

The speaker 22 is configured as a loud speaker for outputting a sound of an audible frequency band in accordance with the sound signal (SD) amplified by the sound amplifier 21. This speaker corresponds to the left and right stereo speakers 22a and 22b provided on the cabinet top face of the computer main body 110 shown in FIG. 1.

The sound input sensor 23 detects an analog sound signal (AUD) inputted from an external device, and outputs an analog sound information detection signal (ADT) during the sensing. The OR circuit 25 inputs the analog sound information detection signal (ADT) and the digital sound data detection signal (DDT) outputted from the sound controller 18.

The sound output sensor 24 detects a state of a sound output outputted from the speaker 22 (22a, 22b) via the sound amplifier 21, and sends a sound output detection signal (ODT) to the EC/KBC 19 during the sensing.

The digital sound data detection signal (DDT) is inputted from the sound controller 18 to the OR circuit 25, and the analog sound information detection signal (ADT) is inputted from the sound input sensor 23 to the OR circuit 25, and the sound detection signal (SDT) is outputted according to the input of either or both of these detection signals. The sound detection signal (SDT) is sent to the keyboard embedded controller (EC/KBC) 19 together with the sound output detection signal (ODT) outputted from the sound output sensor 24.

The sound monitor 26 is controlled with the sound monitor drive signal (SMD) outputted from the EC/KBC 19, and notifies a user of a state of sound information. This sound monitor 26 corresponds to the displays 26a and 26b provided at the lower part on the front face of the display unit (display unit cabinet) 120 shown in FIG. 1.

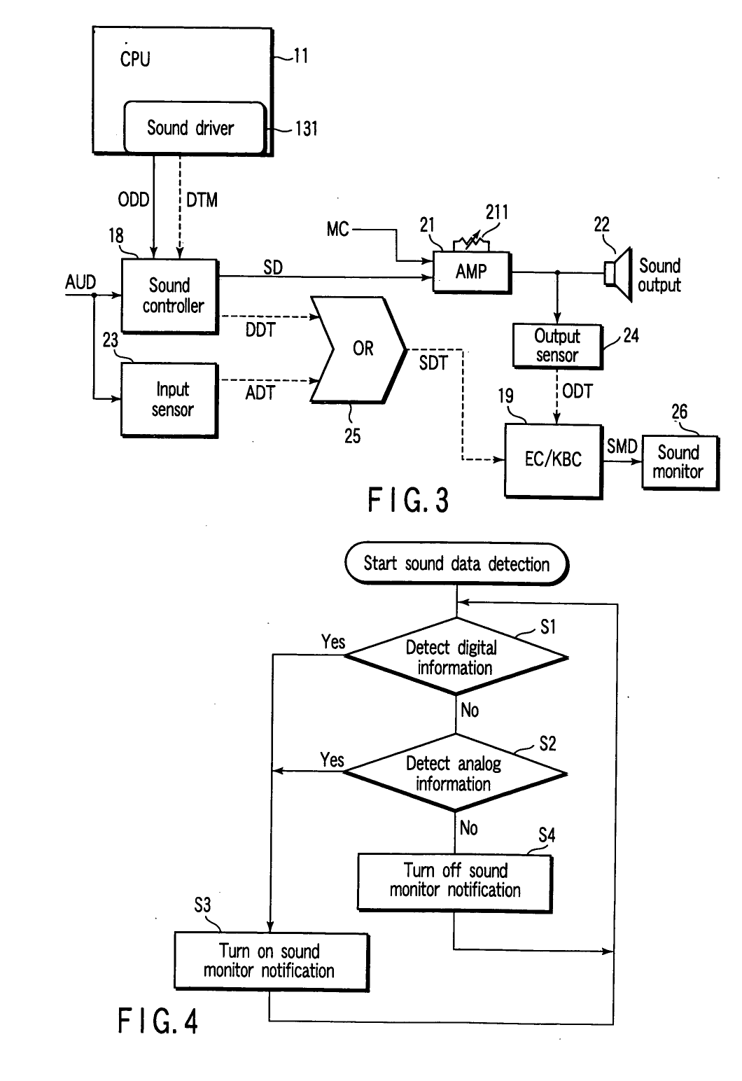

FIG. 3 is a block diagram depicting a configuration of essential portions of the present invention, wherein constituent elements directly related to the present invention are excerpted and simplified from system constituent elements shown in FIG. 2, and the flow of sound information and a variety of signals are clarified. Like portions of the constituent elements shown in FIG. 2 are designated by like reference numerals. Here, the flow of sound information is indicated by the solid line, and the other control signals, detection signals and the like are indicated by the dashed lines, respectively.

FIG. 4 is a flow chart showing procedures for processing in the first embodiment of the present invention. This processing can be achieved by processing of a microprocessor in the EC/KBC 19, for example. According to the first embodiment shown in FIG. 4, the EC/KBC 19 controls an operation of the sound monitor 26 by using only the sound detection signal (SDT) outputted from the OR circuit 25 without using the sound output detection signal (ODT) outputted from the sound output sensor 24.

An operation in the first embodiment of the present invention will be described with reference to each of the above described figures.

The sound information handled in the information processing apparatus is roughly classified into an analog sound signal (AUD) and digital sound data (ODD). The analog sound signal (AUD) is supplied from, for example, an external reproducing device or the like. The digital sound data (ODD) is acquired by a reproduction output or the like of the optical disk drive (ODD) 17, for example.

Of these items of sound information, the sound driver 131 detects the digital sound data (ODD). The sound driver 131 sends a detected message (DTM) to the sound controller 18 when the driver detects digital sound data in the system internal processing.

The sound controller 18 having received the detected message (DTM) of digital sound data from the above described sound driver 131 sends the digital sound data detection signal (DDT) to the OR circuit 25.

The sound controller 18 and the sound input sensor 23 input the analog sound signal (AUD) outputted from an external device.

The sound input sensor 23 having detected an input of the analog sound signal (AUD) sends the analog sound information detection signal (ADT) to the OR circuit 25.

When the digital sound data detection signal (DDT) has been inputted from the sound controller 18 or when the analog sound information detection signal (ADT) has been inputted from the sound input sensor 23, the OR circuit 25 sends the sound detection signal (SDT) to the EC/KBC 19 according to input of either of these detection signals.

When the sound amplifier 21 amplifies the sound signal (SD) outputted from the sound controller 18, and the speaker 22 (22a and 22b) outputs a sound, the sound output sensor 24 detects its state, and sends the sound output detection signal (ODT) to the EC/KBC 19.

When the EC/KBC 19 inputs the sound output detection signal (ODT) from the sound output sensor 24, and inputs the sound detection signal (SDT) from the OR circuit 25, the EC/KBC 19 generates a sound monitor drive signal (SMD) on the basis of these signals. The EC/KBC 19 controls an operation of the sound monitor by the sound monitor drive signal (SMD).

FIG. 4 shows a processing procedure in this case. In processing of the first embodiment shown in FIG. 4, the EC/KBC 19 controls an operation of the sound monitor 26 by using only the sound detection signal (SDT) outputted from the OR circuit 25 without using the sound output detection signal (ODT) outputted from the sound output sensor 24.

The sound controller 18 having detected digital sound data outputs the digital sound data detection signal (DDT). Further, the sound input sensor 23 having detected analog sound information outputs an analog sound information detection signal (ADT).

The EC/KBC 19 operates the sound monitor 26 when receiving the sound detection signal (SDT) from the OR circuit 25 in accordance with the digital sound data detection signal (DDT) outputted from the sound controller 18 or the analog sound information detection signal (ADT) outputted from the sound input sensor 23 (steps S1 to S3 of FIG. 4). As a specific example, the EC/KBC 19 controls light emission of the displays 26a and 26b using an LED, shown in FIG. 1, according to an input level of sound information.

In addition, when the digital sound data detection signal (ADT) is not outputted from the sound controller 18, and the analog sound information detection signal (ADT) is not outputted from the sound input sensor 23, the EC/KBC 19 pauses a notifying operation by the sound monitor 26 (steps S1, S2, and S4 of FIG. 4).

Even if a sound output is disabled by control of the sound monitor 26, for example, volume adjustment means with volume control, a sound mute circuit and the like, the state of sound information handled at the inside can be easily recognized by the sound monitor 26. In this manner, a defect on information together with a sound output or the like can be reliably prevented. In addition, a variety of processing operations together with the sound output can be smoothly carried out and reliability and operability can be improved. In the first embodiment, also when a sound is outputted from the speaker 22 (22a and 23b), the sound monitor 26 displays its sound output state at the same time. Thus, sound information can be reliably recognized on both of audio and visual detects, and a monitor effect can be achieved even in the case where the sound output content such as the use under a noisy environment is hardly audible.

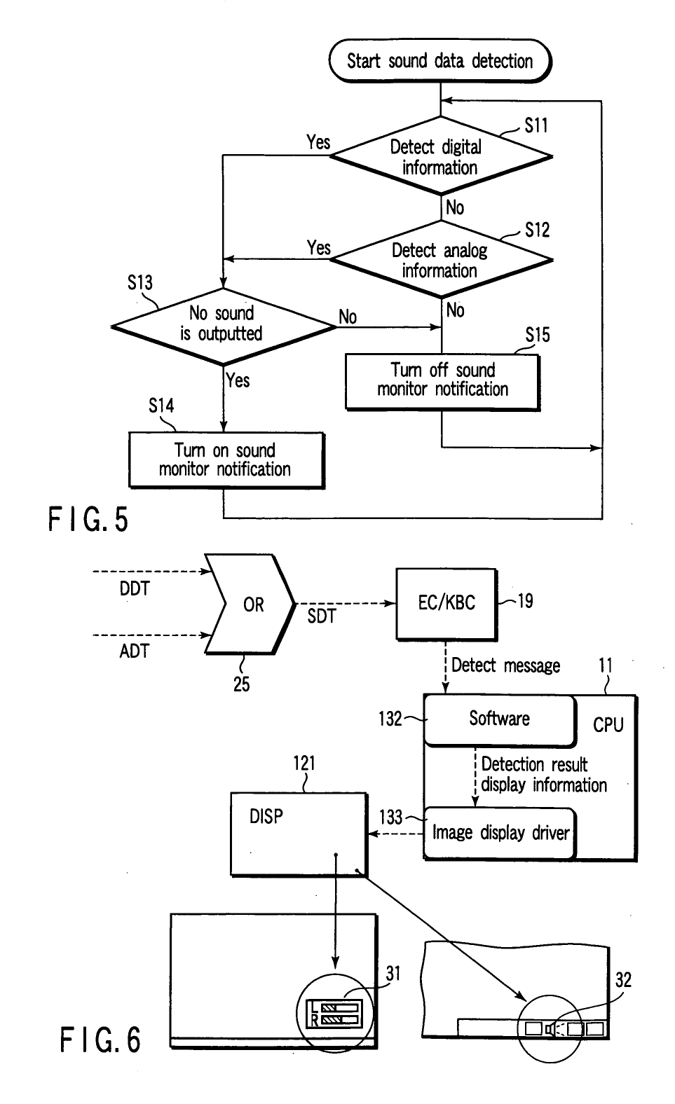

An operation in a second embodiment of the present invention will be described with reference to FIG. 5.

In processing of the second embodiment shown in FIG. 5, the EC/KBC 19 generates a sound monitor drive signal (SMD) based on a sound output detection signal (ODT) outputted from the sound output sensor 24 and a sound detection signal (SDT) outputted from the OR circuit 25, and controls an operation of the sound monitor 26 by the sound monitor drive signal (SMD).

When the EC/KBC 19 has received a sound detection signal (SDT) from the OR circuit 25 in accordance with a digital sound data detection signal (DDT) outputted from the sound controller 18 or an analog sound information detection signal (ADT) outputted from the sound input sensor 23, if the sound output detection signal (ODT) is not inputted from the sound output sensor 24, the EC/KBC 19 operates the sound monitor 26 (steps S11 to S14 of FIG. 5). Further, when receiving the sound detection signal (SDT) from the OR circuit 25, if the sound output detection signal (ODT) is inputted from the sound output sensor 24, the EC/KBC 19 does not operate the sound monitor 26 (steps S11 to S13 and S15 of FIG. 5)

By such control of the sound monitor 26, even if a sound output is disabled by, for example, volume adjustment means with volume control, a sound mute circuit and the like, the state of sound information handled at the inside can be easily recognized by the sound monitor 26. In this manner, a defect on information together with a sound output or the like can be reliably prevented. In addition, a variety of processing operations together with a sound output can be smoothly carried out and reliability and operability can be improved. Moreover, in the second embodiment, only when a sound is not outputted from the speaker 22 (22a and 22b), the sound monitor 26 displays its sound output state. Thus, while complication of an operation together with an operation of the sound monitor 26 is eliminated, the sound information handled in the system can be precisely recognized.

An operation in a third embodiment of the present invention will be described with reference to FIG. 6.

The third embodiment shown in FIG. 6 shows an example of notifying a state of sound information handled in the system by using the display device 121 instead of the sound monitor 26.

The EC/KBC 19 having received a sound detection signal (SDT) from the OR circuit 25, the EC/KBC 19 notifies software 132, which operates on the CPU 11, of its detected message. The software 132 displays the state of sound information in a predetermined display format on the display device 121 via an image display driver 133 operating on the CPU 11 similarly.

A display example in this case is designated by reference numerals 31 and 32 in FIG. 6. In a display format displayed by a level meter, for example, on a desktop screen as designated by reference numeral 31, the state of sound information handled in the system can be precisely recognized in a state in which its display window is visually allocated at an arbitrary position on a display screen. In addition, in a display format displayed by icons on a system tray, as designated by reference numeral 32, the state of sound information handled in the system can be recognized without any problem with a work using the display screen.

As described above, by providing means for detecting a state of sound information, even if a sound output is disabled by, for example, means for adjusting a volume with volume control, a sound mute circuit and the like, the user can recognize the state of sound information handled at the inside via the above-described means for detecting the state. In this manner, a defect on information together with a sound output or the like can be reliably prevented. In addition, a variety of processing operations together with a sound output can be carried out smoothly, and reliability and operability can be improved.

According to the embodiments of the present invention, the state of handing sound data can be precisely notified to the user regardless of an operation for disabling a sound output.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An information processing apparatus comprising:
means for disabling an output of sound information;
means for detecting a state of the sound information; and
means for notifying a user of the state of the sound information detected with the means for detecting the state by using information other than a sound.

2. The information processing apparatus according to claim 1, wherein the means for detecting the state detects the state of the sound information in a case where the means for disabling the output is active.

3. The information processing apparatus according to claim 1, wherein the means for notifying the user notifies the user of the state of the sound information in a case where the means for disabling the output is active.

4. The information processing apparatus according to claim 1, wherein the means for detecting the state detects the state of sound information targeted for analog sound information and digital sound information.

5. The information processing apparatus according to claim 4, wherein the means for detecting the state comprises:
a sound controller connected to a CPU via a bus, controlling input and output of digital sound information via the bus and controlling input and output of analog sound information; and
means for sensing a state of the sound information which is inputted or outputted by the sound controller,
wherein the means for notifying the user notifies the user of the state of the sound information detected by the means for sensing the state.

6. The information processing apparatus according to claim 5, wherein the means for sensing the state further comprises:
means for sensing a sound output state of the sound information outputted from the sound controller; and
an input/output controller which controls the means for notifying the user based on the state of the sound information sensed by the means for sensing the state and the sound output state of the sound information sensed by the means for sensing the sound output state.

7. The information processing apparatus according to claim 1, wherein the means for notifying the user notifies the user of the state of the sound information detected by the means for detecting the state by using means for emitting light.

8. The information processing apparatus according to claim 1, wherein the means for notifying the user notifies the user of the state of the sound information detected by the means for detecting the state by using vibrating means.

9. The information processing apparatus according to claim 1, wherein the means for notifying a user outputs the state of the sound information detected by the means for detecting the state to display the state of the sound information on a display screen.

10. The information processing apparatus according to claim 1, wherein the means for disabling the output includes at least one of a volume adjustment circuit and a sound mute circuit.

11. A method of notifying a state of an information processing apparatus which handles sound information, the method comprising:
detecting a state of sound information handled by the information processing; and
notifying the state of the detected sound information.

12. The state notifying method according to claim 11, wherein the information processing apparatus comprises:
means for outputting a sound in accordance with sound information; and
means for disabling a sound output of the sound outputting means,
wherein notifying the state of the sound information notifies a state of sound information detected by detecting a state of the sound information when a sound output of the means for outputting the sound is disabled by the means for disabling the sound output.

13. The state notifying method according to claim 11, wherein the information processing apparatus comprises:
means for outputting a sound in accordance with sound information; and
means for disabling a sound output of the sound outputting means,
wherein notifying the state of the sound information notifies a state of the sound information detected by detecting a state of the sound information regardless of an operation state of the means for disabling the sound output.
